(19) United States
(12) Patent Application Publication
(10) Pub. No.: US 2006/0191146 A1
(43) Pub. Date: Aug. 31, 2006

(54) Disposable spoon

(76) Inventor: Chao-Hui Chao, Hemei Town (TW)

Correspondence Address: CHARLES E. BAXLEY, ESQ., 90 JOHN STREET, THIRD FLOOR, NEW YORK, NY, 10038, US

(21) Appl. No.: 11/067,988

(22) Filed: Feb. 28, 2005

(51) Int. Cl. A47J 43/28

(52) U.S. Cl. 30/324

(57) ABSTRACT

A disposable spoon is disclosed to include a handle, which has an elongated, longitudinally extending flat base, two obliquely upwardly extending sidewalls at two sides of the flat base, and a ridged line between the flat base and each sidewall, and a bowl, which has a flat base connected to the flat base of the handle at an angle, two sidewalls obliquely upwardly disposed at two sides of the flat base and respectively formed integral with the sidewalls of the handle, a front wall obliquely forwardly extending from a front end of the flat base and terminating in a transversely extending straight edge, and a ridged line between the flat base and each sidewall and between the front wall and each sidewall.

### BACKGROUND OF THE INVENTION

1. Field of the Invention

The present invention relates to a spoon and more particularly, to a disposable spoon, which has ridged lines that reinforce the structural strength of the spoon, and a transversely extended straight edge at the free end of the front wall that facilitates pickup of foods.

2. Description of the Related Art

A conventional disposable spoon, as shown in FIG. 1, is injection-molded from plastics, comprising a handle 10 and a bowl 11 at the front end of the handle 10. The handle 10 has a substantially U-shaped cross section. In order to reinforce the structural strength, the border area of the handle 10 is made having a downwardly curved border portion 12 that extends to the bowl 11. Further, the bowl 11 has a smoothly curved narrow front side convenient for insertion into foods. However, this smoothly curved narrow front side has a weak structural strength. When inserted the bowl 11 into the food, the bowl may be deformed easily upon a reactive force. Further, the smoothly curved narrow front side limits the capacity of the bowl in picking up solid foods.

Further, when a number of disposable spoons are arranged in a stack, the downwardly curved border portion 12 of one disposable spoon will be firmly retained to another. When separating two attached disposable spoons, the user may have to insert the nail of one finger into the gap between the downwardly curved border portions 12 of the two disposable spoons.

### SUMMARY OF THE INVENTION

The present invention has been accomplished under the circumstances in view. It is therefore the main object of the present invention to provide a disposable spoon, which has ridged lines that reinforce the structural strength of the handle and the bowl. It is another object of the present invention to provide a disposable spoon, which has a reinforced structural design, preventing deformation of the bowl upon a reactive force during insertion of the bowl into the foods. It is still another object of the present invention to provide a disposable spoon, which has a flat front wall terminating in a transversely extending straight edge conveniently for picking up foods at a big amount. It is still another object of the present invention to provide a disposable spoon, which allows convenient separation of disposable spoons that are arranged in a stack.

To achieve these and other objects of the present invention, the disposable spoon comprises a handle and a bowl at one end of the handle. The handle has an elongated, longitudinally extending flat base, two obliquely upwardly extending sidewalls at two sides of the flat base, and a ridged line between the flat base and each sidewall. The bowl has a flat base connected to the flat base of the handle at an angle, two sidewalls obliquely upwardly disposed at two sides of the flat base and respectively formed integral with the sidewalls of the handle, a front wall obliquely forwardly extending from a front end of the flat base and terminating in a transversely extending straight edge, and a ridged line between the flat base and each sidewall and between the front wall and each sidewall.

### BRIEF DESCRIPTION OF THE DRAWINGS

FIG. 1 is an elevational view of a disposable spoon according to the prior art.

FIG. 2 is a sectional view of the disposable spoon according to the prior art.

FIG. 3 is an oblique top elevation of a disposable spoon according to the present invention.

FIG. 4 is an oblique bottom elevation of the disposable spoon according to the present invention.

FIG. 5 is a top plain view of the disposable spoon according to the present invention.

FIG. 6 is a side view showing a number of disposable spoons arranged in a stack according to the present invention.

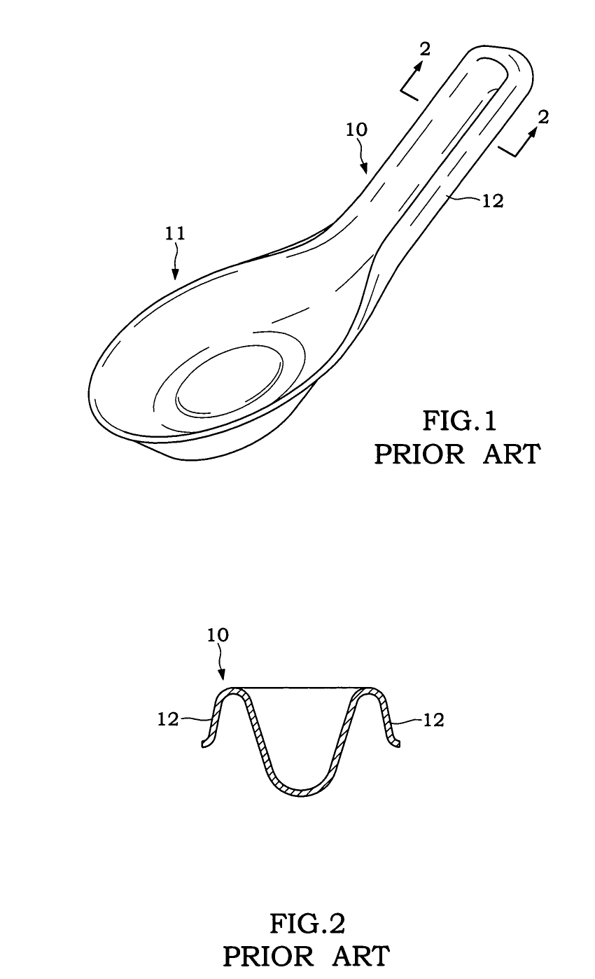

### DETAILED DESCRIPTION OF THE PREFERRED EMBODIMENT

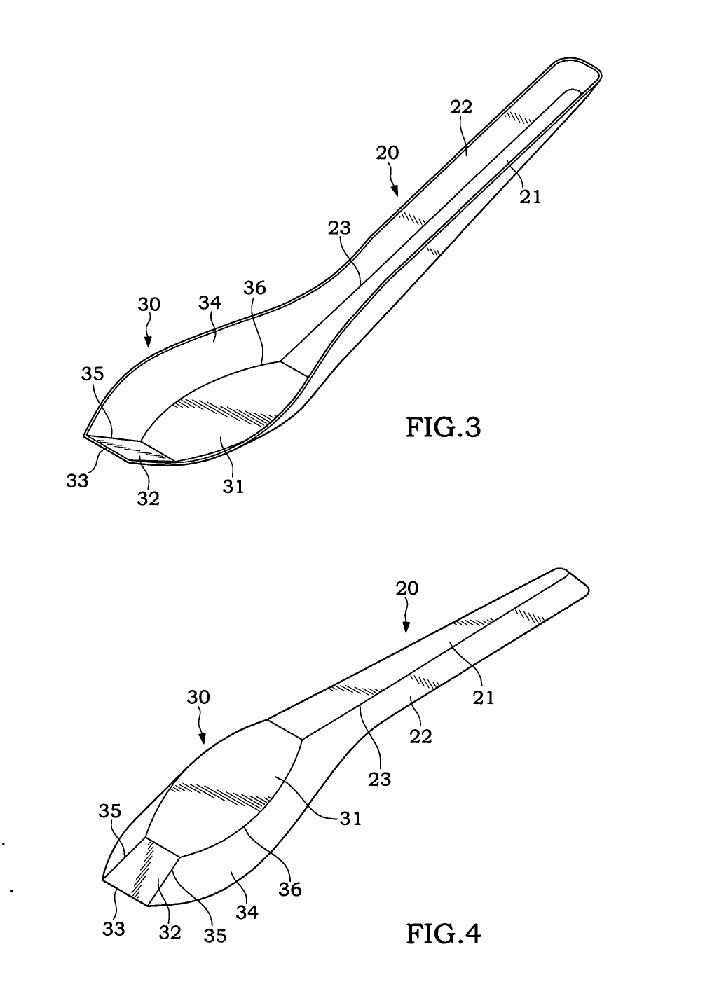

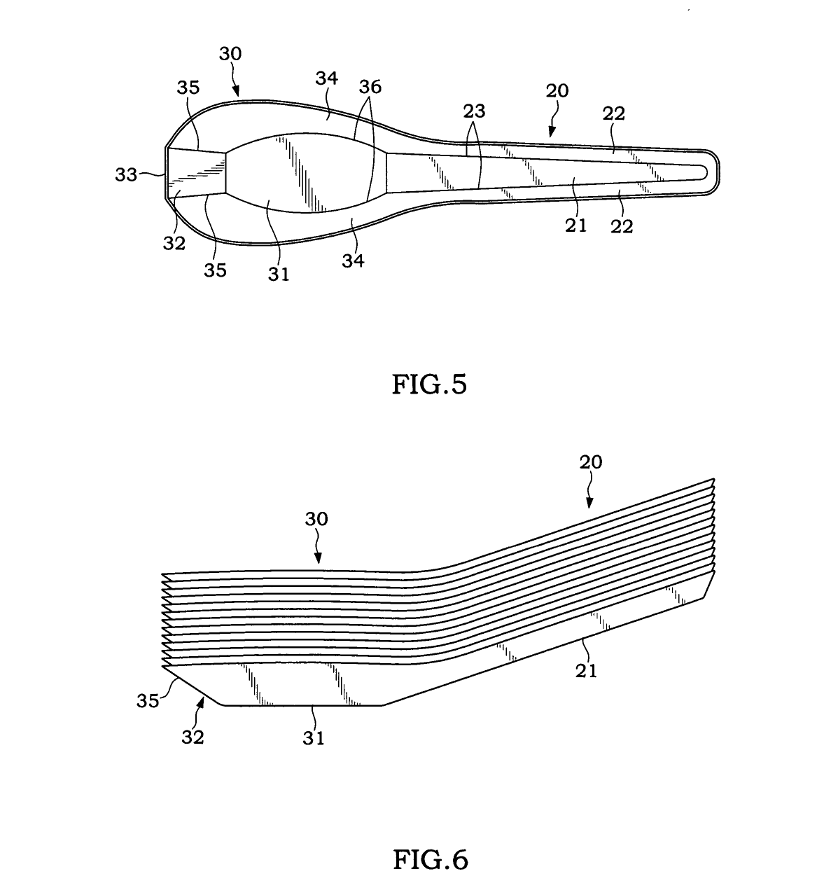

Referring to FIGS. 3˜5, a disposable spoon is shown molded from plastics, comprising a handle 20 and a bowl 30 formed integral with one end of the handle 20. The handle 20 and the bowl 30 each have a flat base 21 or 31. The flat base 21 of the handle 20 has a longitudinally extending elongated shape. The flat base 31 of the bowl 30 has a substantially oval shape connected to one end of the flat base 21 of the handle 20. The front side of the bowl 30 is a front wall 32 obliquely upwardly extending from one end, namely, the front end of the flat base 31 remote from the handle 20. The free end (topmost edge) of the front wall 32 is a transversely extended straight edge 33. The handle 20 and the bowl 30 each further have two obliquely upwardly extending sidewalls 22 or 34 at two sides of the respective flat base 21 or 31, and a ridged line 23 or 36 between the flat base 21 or 31 and each sidewall 22 or 34. The two sidewalls 22 of the handle 20 are merged into each other at the rear end. The two sidewalls 34 of the bowl 30 are smoothly curved and connected between the sidewalls 22 of the handle 20 and the two sides of the front wall 32. The straight edge 33 is in flush with the sidewalls 34 of the bowl 30. The bowl 30 further has a ridged line 35 between each sidewall 34 and the front wall 32. The ridged lines 23, 35, 36 greatly reinforce the structural strength of the disposable spoon, preventing deformation of the bowl 30 upon a reactive force at the front wall 32 and the straight edge 33 after insertion of the bowl 30 into the food. Further, by means of the straight edge 33, the disposable spoon can pick up past or cream-like food conveniently. The reinforced structural design of the bowl 30 allows convenient pickup of a big amount of food.

As indicated above, the ridged lines 23, 35, 36 greatly reinforce the structural strength of the handle 20 and the bowl 30. Therefore, it is not necessary to have the sidewalls 22, 34 curved outwardly inwards in transverse direction as the conventional disposable spoons. When a number of disposable spoons are arranged together in a stack, they do not interfere with one another, and the user can conveniently separate the stack of disposable spoon from one another.

Although a particular embodiment of the invention has been described in detail for purposes of illustration, various modifications and enhancements may be made without departing from the spirit and scope of the invention.

What the invention claimed is:

1. A disposable spoon comprising a handle, said handle having a front end and a rear end, and a bowl connected to the front end of said handle, wherein:
said handle comprises an elongated, longitudinally extending base, and two obliquely upwardly extending sidewalls at two sides of the base of said handle;
said bowl comprises a base connected to one end of the base of said handle, two sidewalls obliquely upwardly disposed at two sides of the base of said bowl and respectively formed integral with the sidewalls of said handle, and a front wall obliquely forwardly extending from a front end of the base of said bowl remote from said handle and connected between the sidewalls of said bowl, said front wall having a free end terminating in a transversely extending straight edge.

2. The disposable spoon as claimed in claim 1, which is molded from plastics.

3. The disposable spoon as claimed in claim 1, wherein the base of said handle is a flat member.

4. The disposable spoon as claimed in claim 1, wherein the base of said bowl is a flat member.

5. The disposable spoon as claimed in claim 1, wherein said handle further comprises a ridged line connected between the base of said handle and each sidewall of said handle.

6. The disposable spoon as claimed in claim 1, wherein said bowl further comprises a ridged line connected between the base of said bowl and each sidewall of said bowl.

7. The disposable spoon as claimed in claim 1, wherein said bowl further comprises a ridged line connected between the front wall and each sidewall thereof.

8. The disposable spoon as claimed in claim 1, wherein the sidewalls of said handle are merged into each other at one end remote from said bowl.

9. The disposable spoon as claimed in claim 1, wherein the base of said bowl has an oval shape.

10. The disposable spoon as claimed in claim 9, wherein the two sidewalls of said bowl are smoothly curved in longitudinal direction and respectively connected between the two sidewalls of said handle and two sides of said front wall of said bowl.

11. The disposable spoon as claimed in claim 1, wherein said straight edge of said bowl is in flush with the topmost edge of each of the two sidewalls of said bowl.
